(19) United States
(12) Patent Application Publication
(10) Pub. No.: US 2024/0357504 A1
(43) Pub. Date: Oct. 24, 2024

(54) MULTI-LINK OPERATION FOR NEXT GENERATION WLAN

(71) Applicant: Samsung Electronics Co., Ltd., Suwon-si (KR)

(72) Inventors: Rubayet Shafin, Allen, TX (US); Boon Loong Ng, Plano, TX (US); Peshal Nayak, Plano, TX (US); Vishnu Vardhan Ratnam, Plano, TX (US); Yue Qi, Plano, TX (US); Elliot Jen, Taipei (TW)

(21) Appl. No.: 18/443,039

(22) Filed: Feb. 15, 2024

Related U.S. Application Data
(60) Provisional application No. 63/460,235, filed on Apr. 18, 2023.

(51) Int. Cl. H04W 52/02; H04W 76/15

(52) U.S. Cl. CPC H04W 52/0248; H04W 76/15

(57) ABSTRACT

Methods and apparatuses for facilitating selection between operating modes of MLDs. A non-AP MLD comprises a processor and STAs having first and second links operating in the 5 and 2.4 GHz bands, respectively, with APs of an AP MLD. The processor determines: based on traffic latency/throughput requirements, to operate in STR mode using both links, or, based on power saving requirements, to operate in a single link mode using the second link, or, based on the power savings requirements having a higher priority than the latency/throughput requirements, to operate in EMLSR mode using both links or in the single link mode using the first link. If the power savings and latency/throughput requirements are balanced, the processor determines: in a high contention environment, to operate in EMLSR mode using both links or, in a low contention environment, to operate in STR mode using both links.

### CROSS-REFERENCE TO RELATED APPLICATION AND CLAIM OF PRIORITY

This application claims priority under 35 U.S.C. § 119 (e) to U.S. Provisional Patent Application No. 63/460,235 filed on Apr. 18, 2023, which is hereby incorporated by reference in its entirety.

### TECHNICAL FIELD

This disclosure relates generally to power management in wireless communications systems that include multi-link devices. Embodiments of this disclosure relate to methods and apparatuses that facilitate dynamic selection between different operating modes of multi-link devices depending on performance and power saving requirements in a wireless local area network communications system.

### BACKGROUND

Wireless local area network (WLAN) technology allows devices to access the internet in the 2.4 gigahertz (GHz), 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA). With bandwidth aggregation across multiple channels/bands, MLO offers significant gain in throughput and latency performance compared to single link operation in the previous generation (802.11ax).

The non-AP MLDs in 802.11be can have different capabilities in terms of multi-link operation. The current specification defines two special kinds of multi-link operations, namely, Enhanced Multi-Link Single Radio (EMLSR) operation and Enhanced Multi-Link Multi-Radio (EMLMR) operation.

Many 802.11be non-AP MLDs may only have a single radio. EMLSR enables a multi-link operation with a single radio. With EMLSR operation, such a non-AP MLD can achieve throughput enhancement with reduced latency-a performance close to concurrent dual radio non-AP MLDs.

EMLMR operation is another mode of operation newly defined in the IEEE 802.11be specification. With the EMLMR mode of operation, it is possible for an MLD with multiple radios to move transmit (TX)/receive (RX) chains from one link (e.g., a first link) to another link (e.g., a second link) of the same MLD, essentially increasing the spatial stream capability of the second link.

### SUMMARY

Embodiments of the present disclosure provide methods and apparatuses that facilitate dynamic selection between different operating modes of MLDs in a WLAN depending on performance and power saving requirements.

In one embodiment, a non-AP MLD is provided, comprising STAs and a processor operably coupled to the STAs. The STAs each comprise a transceiver configured to form a link with a corresponding AP of an AP MLD, wherein a first of the links operates in the 5 GHz frequency band and a second of the links operates in the 2.4 GHz frequency band. The processor is configured to determine, based on consideration of low latency requirements of traffic or high throughput requirements of the traffic, to operate in a simultaneous transmit and receive (STR) mode of operation using at least the first and second links, or determine, based on consideration of power saving requirements of the non-AP MLD, to operate in a single link mode of operation using the second link, or determine, based on the power savings requirements having a higher priority than the low latency or high throughput requirements, to operate either in an enhanced multi-link single radio (EMLSR) mode of operation using at least the first and second links or in the single link mode of operation using the first link, or determine, based on the power savings requirements and the low latency or high throughput requirements being balanced, whether the non-AP MLD is in a high contention environment or a low contention environment, and: determine, based on the non-AP MLD being in the high contention environment, to operate in the EMLSR mode of operation using at least the first and second links or determine, based on the non-AP MLD being in the low contention environment, to operate in the STR mode of operation using at least the first and second links. The transceivers corresponding to at least the first and second links are further configured to communicate with the corresponding APs of the AP MLD according to the determined mode of operation.

In another embodiment, a method of wireless communication performed by a non-AP MLD that comprises STAs is provided. The STAs each comprise a transceiver configured to form a link with a corresponding AP of an AP MLD, wherein a first of the links operates in the 5 GHz frequency band and a second of the links operates in the 2.4 GHz frequency band. The method comprises the steps of determining, based on consideration of low latency requirements of traffic or high throughput requirements of the traffic, to operate in an STR mode of operation using at least the first and second links, or determining, based on consideration of power saving requirements of the non-AP MLD, to operate in a single link mode of operation using the second link, or determining, based on the power savings requirements having a higher priority than the low latency or high throughput requirements, to operate either in an EMLSR mode of operation using at least the first and second links or in the single link mode of operation using the first link, or determining, based on the power savings requirements and the low latency or high throughput requirements being balanced, whether the non-AP MLD is in a high contention environment or a low contention environment, and: determining, based on the non-AP MLD being in the high contention environment, to operate in the EMLSR mode of operation using at least the first and second links, or determining, based on the non-AP MLD being in the low contention environment, to operate in the STR mode of operation using at least the first and second links. The method further includes the step of communicating with the AP MLD according to the determined mode of operation.

In another embodiment, a non-transitory computer-readable medium is provided. The non-transitory computer-readable medium is configured to store instructions that, when executed by a processor, cause a non-AP MLD to determine, based on consideration of low latency requirements of traffic or high throughput requirements of the traffic, to operate in an STR mode of operation using at least first and second links link formed between STAs of the non-AP MLD and corresponding APs of an AP MLD, wherein the first link operates in the 5 GHz frequency band and the second link operates in the 2.4 GHz frequency band. The instructions, when executed, alternatively cause the non-AP MLD to determine, based on consideration of power saving requirements of the non-AP MLD, to operate in a single link mode of operation using the second link, or determine, based on the power savings requirements having a higher priority than the low latency or high throughput requirements, to operate either in an enhanced multi-link single radio (EMLSR) mode of operation using at least the first and second links or in the single link mode of operation using the first link. The instructions, when executed, alternatively cause the non-AP MLD to determine, based on the power savings requirements and the low latency or high throughput requirements being balanced, whether the non-AP MLD is in a high contention environment or a low contention environment, and: determine, based on the non-AP MLD being in the high contention environment, to operate in the EMLSR mode of operation using at least the first and second links, or determine, based on the non-AP MLD being in the low contention environment, to operate in the STR mode of operation using at least the first and second links. The instructions, when executed, further cause the non-AP MLD to communicate with the AP MLD according to the determined mode of operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example of transitioning into EMLSR operation according to embodiments of the present disclosure;

FIG. 4 illustrates an example of EMLMR operation according to embodiments of the present disclosure;

FIG. 5 illustrates an example network topology according to various embodiments of the present disclosure;

FIG. 6 illustrates simulation results for Topology-1 according to embodiments of the present disclosure;

FIG. 7 illustrates simulation results for Topology-2 according to embodiments of the present disclosure;

FIG. 8 illustrates an example process for MLO control according to embodiments of the present disclosure; and

FIG. 9 illustrates an example process for facilitating dynamic selection between different operating modes of MLDs depending on performance and power saving requirements according to various embodiments of the present disclosure.

### DETAILED DESCRIPTION

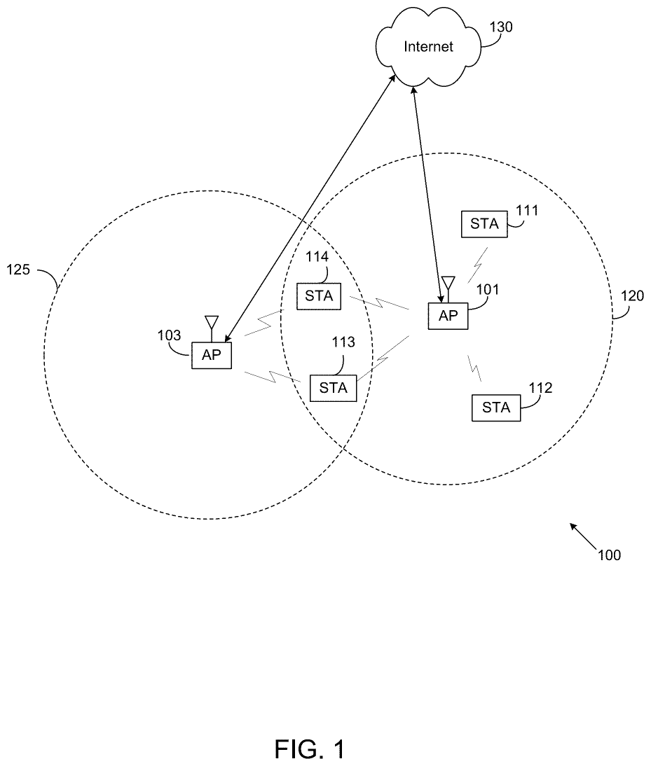

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that multi-link operation introduced in IEEE 802.11be truly opens a new horizon for next generation WLAN with the promise of increased system throughput and lower latency, however, this comes with increased power consumption. The current 802.11 specification is not clear with respect to how, in the presence of competing system design objectives (e.g., high throughput/low latency vs. power saving), MLO should be utilized in the system.

The present disclosure, through extensive experimental analysis, provides insights into how inclusion of an additional link may provide only diminishing gains as compared to single-link operation based on operating conditions (such as overlapping basic service set interference) and provides guidance on how to optimally turn on the multi-link mode of operation to strike a balance between power consumption and throughput/latency performance.

Accordingly, embodiments of the present disclosure provide guidelines and mechanisms for facilitating dynamic selection between single-link and multi-link operating modes of MLDs in a WLAN depending on performance and power saving requirements of the MLDs.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

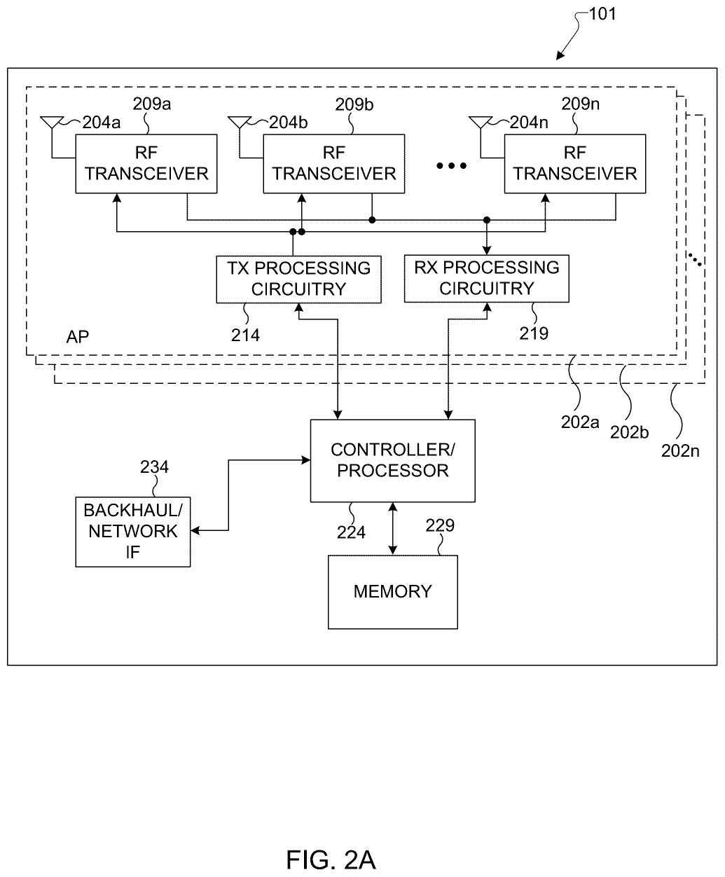

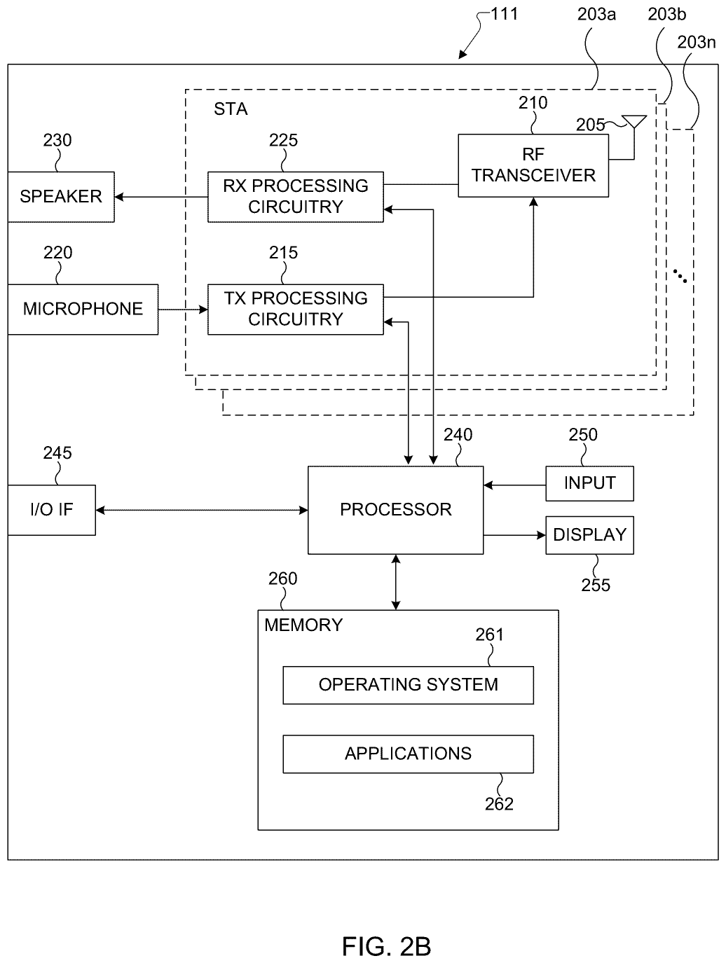

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate dynamic selection between different operating modes depending on performance and power saving requirements of the non-AP MLD. In some embodiments, the controller/processor 240 includes at least one microprocessor or microcontroller.

The controller/processor 240 is also capable of executing other processes and programs resident in the memory 260, such as operations for facilitating dynamic selection between different operating modes depending on performance and power saving requirements of the non-AP MLD. The controller/processor 240 can move data into or out of the memory 260 as required by an executing process. In some embodiments, the controller/processor 240 is configured to execute a plurality of applications 262, such as applications for facilitating dynamic selection between different operating modes depending on performance and power saving requirements of the non-AP MLD. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

The operating procedure for EMLSR links and the behavior of STAs affiliated with a non-AP MLD during EMLSR operation are defined in the 802.11be standards. According to current specifications, if a non-AP MLD intends to operate in EMLSR mode with its associated AP MLD, a STA affiliated with the non-AP MLD sends an EML Operating Mode Notification frame (EOMNF), with the EMLSR Mode subfield in the EML Control field of the frame set to 1, to its associated AP affiliated with the AP MLD.

Upon receiving the EML Operating Mode Notification frame from the non-AP MLD, the AP MLD can send, on any enabled link between the AP MLD and the non-AP MLD, another EML Operating Mode Notification frame with the EMLSR Mode subfield in the EML Control field of the frame set to 1. The AP affiliated with the AP MLD is expected to send the EML Operating Mode Notification frame in response to the EML Operating Mode Notification frame sent by a STA affiliated with the non-AP MLD within the timeout interval indicated in the Transition Timeout subfield in the EML Capabilities subfield in the Basic Variant Multi-Link element that is most recently exchanged between the AP MLD and the non-AP MLD.

The non-AP MLD transitions to EMLSR mode immediately after receiving the EML Operating Mode Notification frame with EMLSR Mode subfield in EML Control field set to 1 from an AP affiliated with the AP MLD, or immediately after the timeout interval indicated in the Transition Timeout subfield in the EML Capabilities field in the Basic Variant Multi-Link element elapses after the end of the last PPDU contained in the EML Operating Mode Notification frame transmitted by the non-AP MLD—whichever occurs first. Upon transitioning into the EMLSR mode of operation, all STAs affiliated with the non-AP MLD transition to active mode (or listening mode).

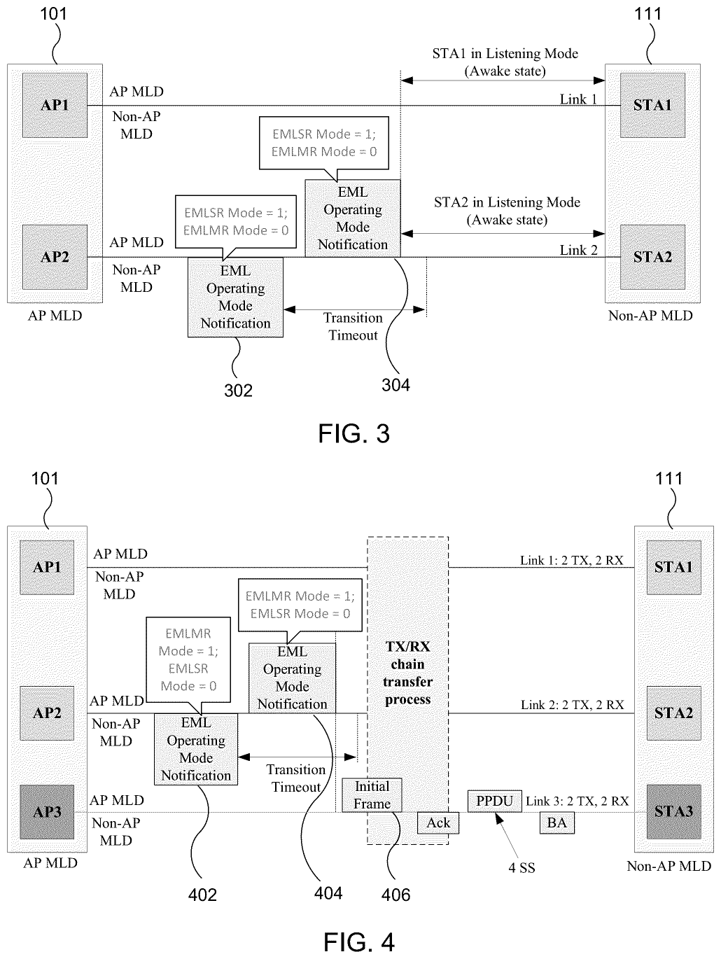

FIG. 3 illustrates an example of transitioning into EMLSR operation according to embodiments of the present disclosure. In this example, the AP MLD may be an AP MLD 101, and the non-AP MLD may be a non-AP MLD 111. Although the AP MLD 101 is illustrated with two affiliated APs (AP1 and AP2) and the non-AP MLD 111 is illustrated as a single radio non-AP MLD with two affiliated non-AP STAs (STA1 and STA2), it is understood that this process could be applied with suitable MLDs having any number of affiliated APs or STAs. For ease of explanation, it is understood that references to an AP MLD and a non-AP MLD in further embodiments below refer to the AP MLD 101 and non-AP MLD 111, respectively.

In the example of FIG. 3, two links are set up between the AP MLD and the non-AP MLD-Link 1 between AP1 and STA1, and Link 2 between AP2 and STA2. Moreover, in this illustration, both Link 1 and Link 2 are enabled links. The non-AP MLD intends to transition to EMLSR mode, and accordingly STA2 sends to AP2 over Link 2 an EML Operating Mode Notification frame 302 with EMLSR Mode subfield in EML Control field set to 1. In response to the EML Operating Mode Notification frame 302 transmitted by the non-AP MLD, AP2 sends to STA2 another EML Operating Mode Notification frame 304 with EMLSR Mode subfield in EML Control field set to 1. After receiving the EML Operating Mode Notification frame 304 from the AP MLD, the non-AP MLD transitions into EMLSR mode, and both STA1 and STA2 transition into listening mode.

The operating procedure for a non-AP MLD in EMLMR mode is also defined in 802.11be standards. According to the current specification, the procedure for a non-AP MLD to transition into EMLMR mode is quite similar to the procedure for transitioning into EMLSR mode. If a non-AP MLD intends to operate in EMLMR mode with its associated AP MLD, a STA affiliated with the non-AP MLD sends an EML Operating Mode Notification frame to its associated AP affiliated with the AP MLD, with the EMLMR Mode subfield in the EML Control field in the EML Operating Mode Notification frame set to 1 (and with the EMLSR Mode subfield in the same frame set to 0).

Upon receiving the EML Operating Mode Notification frame from the non-AP MLD, the AP MLD can send, on any enabled link between the AP MLD and the non-AP MLD, another EML Operating Mode Notification frame with the EMLMR Mode subfield in the EML Control field in the EML Operating Mode Notification frame set to 1. The AP affiliated with the AP MLD is expected to send the EML Operating Mode Notification frame in response to the EML Operating Mode Notification frame sent by the STA affiliated with the non-AP MLD within the timeout interval indicated in the Transition Timeout subfield in EML Capabilities subfield in the Basic Variant Multi-Link element that is most recently exchanged between the AP MLD and the non-AP MLD.

The non-AP MLD transitions to EMLMR mode immediately after receiving the EML Operating Mode Notification frame with EMLMR Mode subfield in EML Control field set to 1 from an AP affiliated with the AP MLD, or immediately after the timeout interval indicated in the Transition Timeout subfield in EML Capabilities field in the Basic Variant Multi-Link element elapses after the end of last PPDU contained in the EML Operating Mode Notification frame transmitted by the non-AP MLD—whichever occurs first.

After the non-AP MLD transitions into EMLMR mode, it is the AP MLD that sends an Initial Frame to the non-AP MLD. The subsequent EMLMR frame exchanges occur on the link on which the AP MLD sends the Initial Frame. According to the current specification, the AP MLD, for EMLMR frame exchanges, shall select one of the links that are included as the EMLMR links. According to the current specification, the Initial Frame can be any frame that is sent by the AP MLD to the non-AP MLD as the first frame after the non-AP MLD transitions into EMLMR mode.

After the AP MLD sends the Initial Frame on a link, the non-AP MLD is able to operate on that link with maximum spatial stream as indicated by the values in the EMLMR Rx NSS and EMLMR Tx NSS subfields in the EML Capabilities subfield of the Common Info field of the Basic Multi-Link element. Immediately after the EMLMR frame exchange sequence is complete, the STAs affiliated with the AP MLD go back to operating with the per-stream spatial capability.

FIG. 4 illustrates an example of EMLMR operation according to embodiments of the present disclosure. In this example, the AP MLD may be an AP MLD 101, and the non-AP MLD may be a non-AP MLD 111. Although the AP MLD 101 is illustrated with three affiliated APs (AP1, AP2, and AP3) and the non-AP MLD 111 is illustrated as a multi-radio non-AP MLD with three affiliated non-AP STAs (STA1, STA2, and STA3), it is understood that this process could be applied with suitable MLDs having any number of affiliated APs or STAs.

In the example of FIG. 4, the AP MLD has three affiliated APs: AP1 operating on 2.4 GHz band, AP2 operating on 5 GHz band, and AP3 operating on 6 GHz band. The non-AP MLD has three affiliated STAs: STA1 operating on 2.4 GHz band, STA2 operating on 5 GHz band, and STA3 operating on 6 GHz band. Three links are established between the AP MLD and the non-AP MLD: Link 1 between AP1 and STA1, Link 2 between AP2 and STA2, and Link 3 between AP3 and STA3. The non-AP MLD is a multi-radio non-AP MLD, where STA1, STA2, and STA3 each have two transmit chains and two receive chains. Both the AP MLD and the non-AP MLD support EMLMR operation. The non-AP AP MLD lists all three links—Link 1, Link 2, and Link 3—as the EMLMR links. In the Basic Multi-Link element exchanged between the AP MLD and the non-AP MLD, the EML Capabilities Present subfield is set to 1 and both the EMLMR Rx NSS and EMLMR Tx NSS subfields in the EML Capabilities subfield are set to the value of 4.

When the non-AP MLD intends to enter into EMLMR mode it sends an EML Operating Mode Notification frame 402 to the AP MLD on Link 2. In EML Operating Mode Notification frame 402, the EMLMR Mode subfield in the EML Control field is set to 1 and the EMLSR Mode subfield in the EML Control field is set to 0. Upon receiving the EML Operating Mode Notification frame 402 on Link 2, AP2 affiliated with the AP MLD sends, in response, another EML Operating Mode Notification frame 404 to the non-AP MLD on Link 2 and sets the EMLMR Mode subfield in the EML Control field to 1 and EMLSR Mode subfield in the EML Control field to 0 in the EML Operating Mode Notification frame 404.

Upon receiving the EML Operating Mode Notification frame 404 from the AP MLD, which is transmitted before the timeout timer indicated in the Transition Timeout subfield in the EML Capabilities subfield in the Basic Multi-Link element expires, the non-AP MLD transitions into EMLMR mode. After the non-AP MLD transitions into EMLMR mode, the AP MLD sends the Initial Frame 406 on Link 3 to initiate frame exchanges for EMLMR operation on Link 3.

Upon receiving the Initial Frame 406 on Link 3, the non-AP MLD transfers 1 transmit chain and 1 receive chain from Link 1 to Link 3, and transfers 1 transmit chain and 1 receive chain from Link 2 to Link 3. After the transmit and receive chain transfer process is complete, Link 3 has 4 transmit chains and 4 receive chains. Therefore, STA3 affiliated with the non-AP MLD can at this point perform transmit and receive operation using 4 spatial streams on Link 3, in accordance with the value set in the EMLMR Rx NSS and EMLMR Tx NSS subfields in the EML Capabilities subfield of the Basic Multi-link element. STA 3 affiliated with the non-AP MLD then sends an Ack frame in response to the initial control frame sent by the AP MLD. Accordingly, the AP MLD performs subsequent PPDU transmission to the non-AP MLD on Link 3 using 4 spatial streams. After the EMLMR frame exchange sequence, STAs affiliated with the non-AP MLD are able to perform based on per-link spatial stream capability.

The two most predominant modes of MLO are the simultaneous transmit and receive (STR) mode and the EMLSR mode. The STR mode of operation allows an EHT MLD to simultaneously transmit or receive on more than one link. This is the most flexible form of MLO, and is expected to provide the best latency and throughput gains. In the EMLSR mode of operation, the client device listens over multiple links and can position its main radio over the link on which it receives an indication from the AP MLD. The EMLSR mode therefore is a low-cost mechanism to enjoy the benefits of multi-link operation.

Although MLO offers significant gains in throughput and latency performance as compared to legacy single-link (or fixed link) operation, it is not clear how, in the presence of competing system design objectives (e.g., high throughput/low latency vs. power saving), MLO should be utilized in the system. The present disclosure evaluates MLO performance under varying operating conditions in comparison with multi-link single radio (MLSR) operation (which is equivalent to legacy fixed link operation) and provides system and methods for prioritizing MLO over MLSR (or single-link) operation.

To evaluate the performance of different MLO operations compared to single-link operations, this disclosure considers two topologies. Topology-1 focuses on a single basic service set (BSS). An AP MLD (e.g., an AP MLD 101) is placed at the center of a 30 m×30 m square region. Four client devices (e.g., non-AP MLDs 111) are randomly placed around the AP MLD. The first one is an EMLSR device, which can operate on both the 5 GHz and the 2.4 GHz bands but can operate only on one of the links at a time. The second client device is an MLSR device that operates on the 5 GHz band only; this can also be a legacy device that predates 802.11be devices and operates only on the 5 GHz band. The third client device associated with the AP MLD is an MLSR device that operates only on the 2.4 GHz band. Finally, the fourth client device is an STR device that is capable of simultaneously operating on both the 5 GHz band and the 2.4 GHz band.

In order to contrast single BSS system performance with performance under overlapping BSS (OBSS) interference, Topology-2 includes two AP MLDs placed in the same 30 m×30 m square region. Four client devices are associated with each of the AP MLDs—an EMLSR device operating on the 5 GHz and 2.4 GHz bands, an MLSR device operating on the 5 GHz band only, an MLSR device operating on the 2.4 GHz band only, and an STR device capable of simultaneously operating on both the 5 GHz and 2.4 GHz bands.

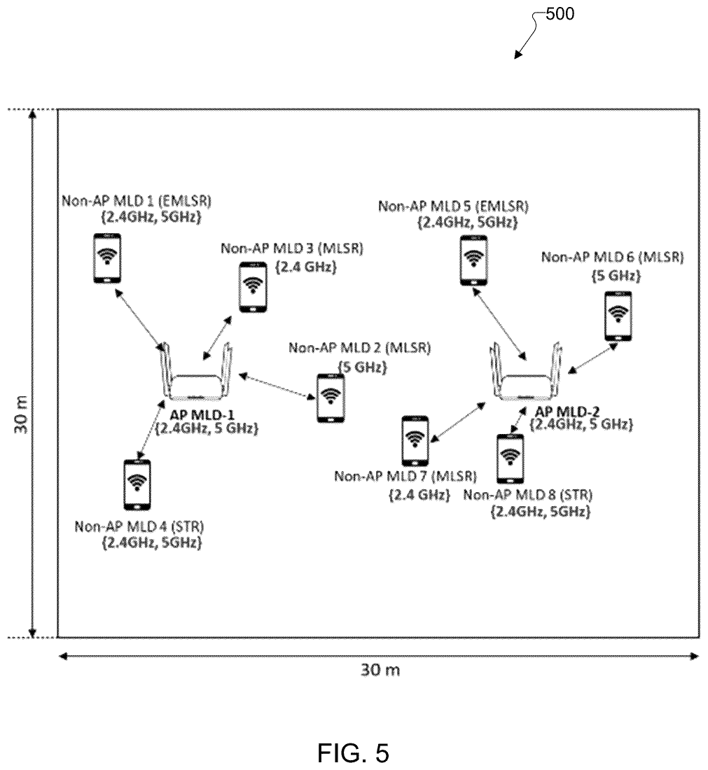

FIG. 5 illustrates an example network topology 500 according to various embodiments of the present disclosure. The network topology 500 corresponds to Topology-2 described above, and includes two AP MLDs (AP MLD-1 and AP MLD-2) placed in the same 30 m×30 m square region. Non-AP MLDs 1-4 are associated with AP MLD-1 while non-AP MLDs 5-8 are associated with AP MLD-2. Non-AP MLDs 1 and 5 are EMLSR devices operating on the 5 GHz and 2.4 GHz bands. Non-AP MLDs 2 and 6 are MLSR devices operating on the 5 GHz band only. Non-AP MLDs 3 and 7 are MLSR devices operating on the 2.4 GHz band only. Finally, non-AP MLDs 4 and 8 are STR devices capable of simultaneously operating on both the 5 GHz and 2.4 GHz bands.

This disclosure includes the results of extensive system-level simulations that evaluate the performances of multi-link devices under varying operating conditions in Topology-1 and Topology-2. The simulations implement the carrier-sense multiple access with collision avoidance (CSMA/CA) protocol and consider Enhanced Distributed Channel Access (EDCA) as the channel access mechanism. All the results are obtained by running each simulation for 0.5 sec and averaging over 5 drops. For each drop, the users are randomly placed within the 30 m×30 m region while keeping the locations of the AP MLD(s) fixed.

For performance evaluation, total throughput and the cumulative distribution function (CDF) of the user perceived throughput (UPT) for each of the devices are considered. The UPT of a packet is defined as (T₂−T₁)/S, where T₁ is the packet generation time at the transmitter, T₂ is the time the packet is successfully received at the receiver, and S is the size of the packet. The UPT is indicative of end-to-end packet latency for a user.

For simulation of MLDs, the transmission queue is managed centrally-whenever a packet arrives at the queue, contention starts on all the available links and the link that wins the contention first can transmit the packet. For both of the topologies, the 5 GHz band and the 2.4 GHz band have operating bandwidths of 80 MHz and 20 MHz, respectively (i.e., asymmetric bandwidth distribution). Finally, a clustered on-off traffic arrival model is implemented: the on and the off periods are exponentially distributed, within the on period the packets arrive at the queue in clusters based on the offered load, and the number of packets per cluster is set to 5. Simulation parameters and their values considered in this disclosure are summarized in Table 1.

TABLE 1

| Parameter | Value |
|---|---|
| No. of TX/RX chain in each link | 1 |
| Channel model | IEEE TGax multipath |
| MCS | 7 |
| Max. #subframes in A-MPDU | 64 |
| Channel access | EDCA |
| Energy detection (ED) threshold | −62 dBm |
| Scheduling method (per link) | Round-robin |

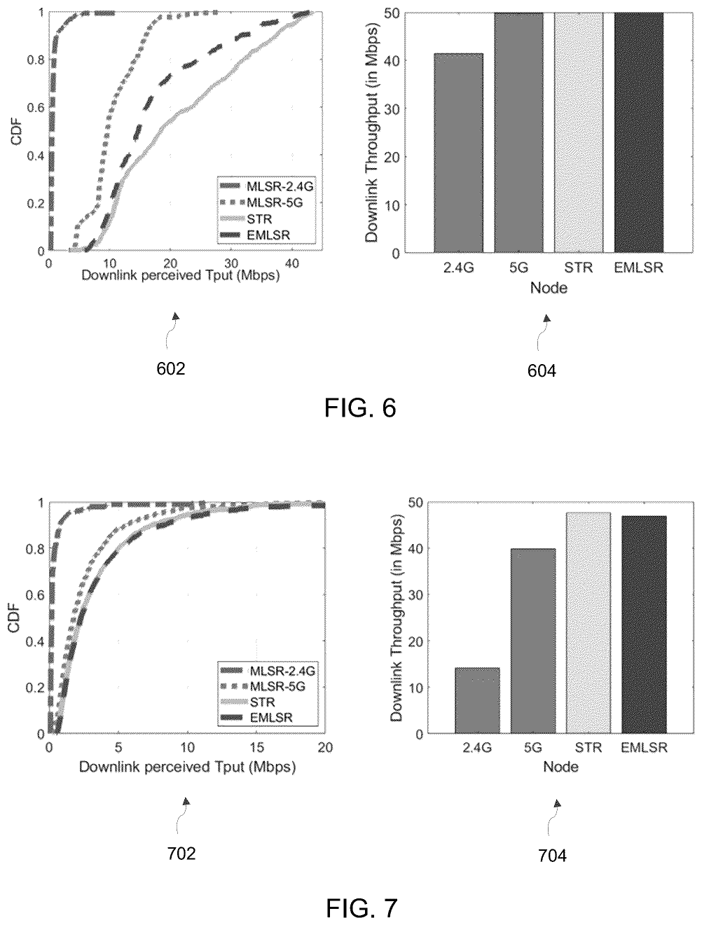

FIG. 6 illustrates simulation results for Topology-1 according to embodiments of the present disclosure. FIG. 6 presents graphs of the UPT CDF 602 and the throughput 604 for downlink traffic simulation in Topology-1 when the offered load is 50 Mbps. It can be observed that most devices can achieve the offered load. However, the STR device outperforms the EMLSR device in UPT by a significant margin. That is, the STR device can flush out the queue at a much faster rate than the EMLSR devices because of the capability of simultaneously transmitting on both links. The MLSR-5 GHz device performs worse than either the STR or EMLSR devices but outperforms the MLSR-2.4 GHz device because of the higher bandwidth associated with the 5 GHz link.

FIG. 7 illustrates simulation results for Topology-2 according to embodiments of the present disclosure. FIG. 7 presents graphs of the UPT CDF 702 and the throughput 704 for downlink traffic simulation in Topology-2 when the offered load is 50 Mbps. The results for different devices are obtained by averaging the results for the corresponding devices associated with the two AP MLDs. For example, the throughput results for the STR device are obtained by averaging the throughput results of the non-AP MLD-4 and non-AP MLD-8. In contrast to the results for Topology-1, in the OBSS environment of Topology-2 none of the devices can actually achieve the offered load of 50 Mbps. Moreover, it can be observed from the UPT results that the performance of the MLSR-5 GHz device closely approaches the performance of the STR and EMLSR devices. This is due to the fact that with increased contention in the network, the likelihood of both links of the STR device simultaneously being available decreases—the overall performance is primarily governed by the availability of the 5 GHz link, and addition of the 2.4 GHz link provides only marginal gain compared to the 5 GHz-only single link operation.

These results illustrate that with little contention in the network STR operation (and to a lesser extent, EMLSR operation) indeed provides significant gains over single-link operation in terms of both latency and throughput performance. However, as contention increases in the network—for example, when OBSS interference is present—the gain provided by STR (and EMLSR) operation becomes incremental. However, the STR and EMLSR modes of operation incur significant power consumption as compared to single-link operation since the radios on both links need to stay on during multi-link operation. Therefore, system designers, based on operating conditions and applications, need to make tradeoffs between incremental improvement of latency/throughput performance and power saving requirements of the system, and switch between single-link and multi-link modes of operation accordingly.

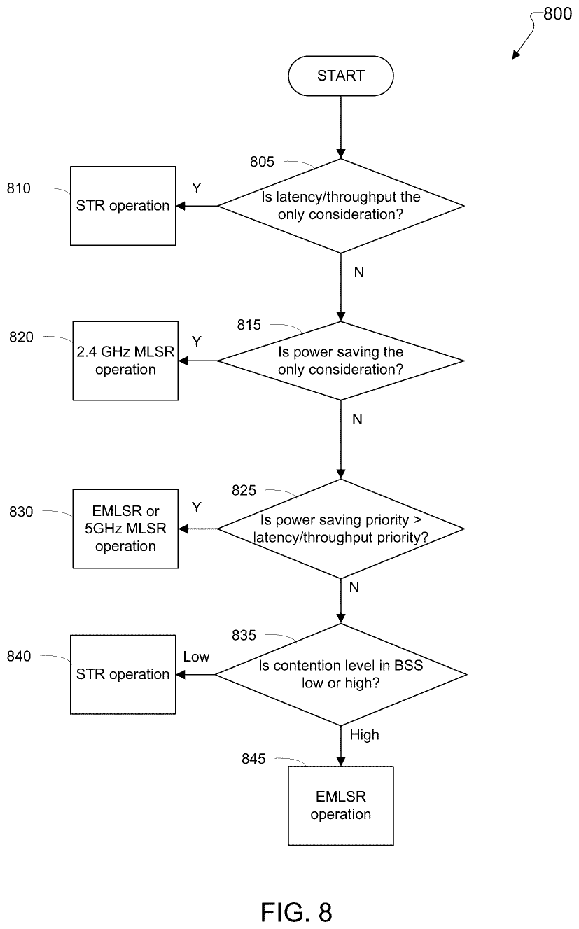

FIG. 8 illustrates an example process 800 for MLO control according to embodiments of the present disclosure. The process 800 illustrates guidance for designing a client non-AP MLD to dynamically switch between single-link and multi-link modes of operation in consideration of system requirements and network conditions. The process 800 may be performed by a non-AP MLD (e.g., a non-AP MLD 111) that is capable of STR operation as well as EMLSR and MLSR operation.

If the only objective is achieving low latency and high throughput (determined at step 805), then the client device is designed to operate in the STR mode of operation (step 810). According to one embodiment, a client device can identify the requirements of low-latency traffic based on the applications that correspond to the traffic. A client device that has low-latency traffic may choose to establish one or more restricted target wake time (R-TWT) schedules with the AP MLD over one or more links.

According to another embodiment, a non-AP MLD that has low-latency or high throughput traffic requirements may set up a stream classification service (SCS) with the AP MLD. In the corresponding SCS Request frame, the non-AP MLD may include a QoS Characteristics element that would include different parameters identifying the requirements of the traffic stream.

According to another embodiment, a non-AP MLD that has low-latency or high throughput traffic requirements may set up a Mirrored Stream Classification Service (MSCS) with the AP MLD. In the corresponding MSCS Request frame, the non-AP MLD may include a QoS Characteristics element that would include different parameters identifying the requirements of the traffic stream.

According to one embodiment, an AP MLD may identify the low-latency traffic requirements of a client device by receiving a QoS Characteristics element from the client device and observing the different timing parameters within the element. Such parameters may include Delay Bound, Service Start Time, Delay-Bounded Burst Size, MSDU Lifetime, and MSDU Delivery Ratio.

According to another embodiment, an AP MLD may identify the throughput requirements of a client device by observing different parameters included in the QoS Characteristics element it received from the client device. Such parameters may include Minimum Data Rate, Mean Data Rate, Maximum MSDU Size, Medium Time, and MSDU Delivery Info.

If the only objective is maximizing power saving while maintaining a minimum throughput or tolerable latency (determined at step 815), then the client device can operate in the MLSR mode using the 2.4 GHz link (step 820).

If the power saving objective has a higher priority than the objectives of achieving low latency or high throughput (determined at step 825), then the client device can operate in the EMLSR mode or in the MLSR mode using the 5 GHz link (step 830).

According to one embodiment, the need for power saving may be identified by the type or nature of applications running on the client device. For example, gaming applications may require more power in general. According to another embodiment, the power-saving need may be identified by the current power management status. For example, if the battery of the client device is running low, then the client device may turn on its power saving mode.

When some balance needs to be struck between the power saving objective and the objectives of achieving low latency or high throughput, the client device can adopt different strategies depending on network operating conditions (determined at step 835). If the client device is in a low contention environment, then it should operate in the STR mode (step 840). If the client device is in a high contention environment, then it should operate in the EMLSR mode (step 845).

According to one embodiment, a low contention environment can be identified by observing the number of OBSS APs in the neighborhood of the non-AP MLD. According to one embodiment, the presence of such OBSS APs can be identified by monitoring different beacons received by the non-AP MLDs, where different beacons may correspond to different APs. According to another embodiment, the presence of OBSS APs can be identified by the non-AP MLD by receiving a Neighbor Report (NR) element or a Reduced Neighbor Report (RNR) element from the AP MLD with which the non-AP MLD is associated. The NR or the RNR element may list different APs that are in the neighborhood of the AP sending the NR or the RNR element.

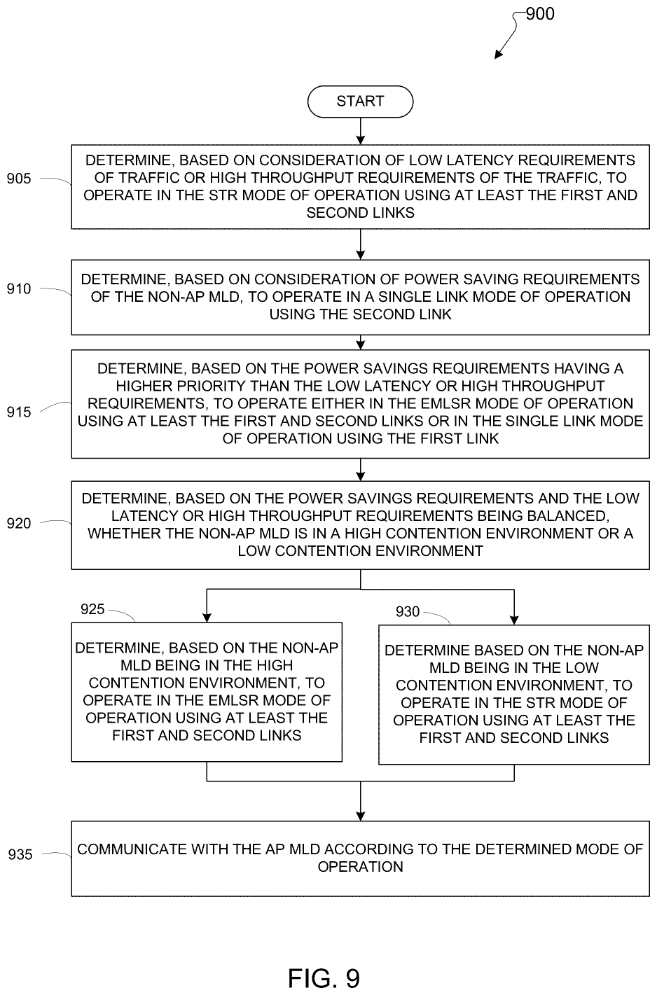

FIG. 9 illustrates an example process 900 for facilitating dynamic selection between different operating modes of MLDs depending on performance and power saving requirements according to various embodiments of the present disclosure. The process 900 of FIG. 9 is discussed as being performed by a non-AP MLD, but it is understood that a corresponding AP MLD performs a corresponding process. Additionally, for convenience the process of FIG. 9 is discussed as being performed by a WI-FI non-AP MLD comprising a plurality of STAs that each comprise a transceiver configured to configured to form a link with a corresponding AP affiliated with a WI-FI AP MLD, wherein a first of the links operates in the 5 GHz frequency band and a second of the links operates in the 2.4 GHz frequency band. However, it is understood that any suitable wireless communication device could perform this process.

Referring to FIG. 9, at step 905 the non-AP MLD may determine, based on consideration of low latency requirements of traffic or high throughput requirements of the traffic, to operate in the STR mode of operation using at least the first and second links.

Alternatively, the non-AP MLD may determine, based on consideration of power saving requirements of the non-AP MLD, to operate in a single link mode of operation (e.g., MLSR operation) using the second link (step 910).

Alternatively, the non-AP MLD may determine, based on the power savings requirements having a higher priority than the low latency or high throughput requirements, to operate either in the EMLSR mode of operation using at least the first and second links or in the single link mode of operation using the first link (step 915).

Alternatively, the non-AP MLD may determine, based on the power savings requirements and the low latency or high throughput requirements being balanced, whether the non-AP MLD is in a high contention environment or a low contention environment (step 920). The non-AP MLD may then determine, based on the non-AP MLD being in the high contention environment, to operate in the EMLSR mode of operation using at least the first and second links (step 925) or, based on the non-AP MLD being in the low contention environment, to operate in the STR mode of operation using at least the first and second links (step 930).

Finally, the non-AP MLD communicates with the AP MLD according to the determined mode of operation (step 935).

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) multi-link device (MLD) comprising:
stations (STAs) each comprising a transceiver configured to form a link with a corresponding AP of an AP MLD, wherein a first of the links operates in a 5 gigahertz (GHz) frequency band and a second of the links operates in a 2.4 GHz frequency band; and
a processor operably coupled to the STAs, the processor configured to:
determine, based on consideration of low latency requirements of traffic or high throughput requirements of the traffic, to operate in a simultaneous transmit and receive (STR) mode of operation using at least the first and second links, or
determine, based on consideration of power saving requirements of the non-AP MLD, to operate in a single link mode of operation using the second link, or determine, based on the power savings requirements having a higher priority than the low latency or high throughput requirements, to operate either in an enhanced multi-link single radio (EMLSR) mode of operation using at least the first and second links or in the single link mode of operation using the first link, or
determine, based on the power savings requirements and the low latency or high throughput requirements being balanced, whether the non-AP MLD is in a high contention environment or a low contention environment, and:
determine, based on the non-AP MLD being in the high contention environment, to operate in the EMLSR mode of operation using at least the first and second links; or
determine, based on the non-AP MLD being in the low contention environment, to operate in the STR mode of operation using at least the first and second links,
wherein the transceivers corresponding to at least the first and second links are further configured to communicate with the corresponding APs of the AP MLD according to the determined mode of operation.

2. The non-AP MLD of claim 1, wherein the processor is further configured to determine the low latency requirements of the traffic based on features of an application that generates the traffic.

3. The non-AP MLD of claim 1, wherein:
the processor is further configured to:
determine, based on the low latency requirements or high throughput requirements of the traffic, to set up a stream classification service (SCS) with the AP MLD; and
generate an SCS Request frame that includes a quality of service (QOS) Characteristics element that includes at least one parameter identifying the low latency requirements or high throughput requirements of the traffic, and
at least one of the transceivers is further configured to transmit the SCS Request frame to the corresponding AP of the AP MLD.

4. The non-AP MLD of claim 1, wherein:
the processor is further configured to:
determine, based on the low latency requirements or high throughput requirements of the traffic, to set up a mirrored stream classification service (MSCS) with the AP MLD; and
generate an MSCS Request frame that includes a QoS Characteristics element that includes at least one parameter identifying the low latency requirements or high throughput requirements of the traffic, and
at least one of the transceivers is further configured to transmit the MSCS Request frame to the corresponding AP of the AP MLD.

5. The non-AP MLD of claim 1, wherein the processor is further configured to:
determine a number of overlapping basic service set (OBSS) APs in a neighborhood of the non-AP MLD; and
determine whether the non-AP MLD is in the high contention environment or the low contention environment based on the number of OBSS APS.

6. The non-AP MLD of claim 5, wherein the processor is further configured to determine the number of OBSS APs based on:
identification of beacons received from APs other than the AP MLD, or
identification of APs other than the AP MLD from a list received from the AP MLD, the list including other APs that are in a neighborhood of the AP MLD.

7. The non-AP MLD of claim 1, wherein the processor is further configured to determine the power savings requirements of the non-AP MLD based on:
applications that are running on the non-AP MLD, or
a power management status of the non-AP MLD.

8. A method of wireless communication performed by a non-access point (AP) multi-link device (MLD) that comprises stations (STAs) each comprising a transceiver configured to form a link with a corresponding AP of an AP MLD, wherein a first of the links operates in the 5 GHz frequency band and a second of the links operates in the 2.4 GHz frequency band, the method comprising:
determining, based on consideration of low latency requirements of traffic or high throughput requirements of the traffic, to operate in a simultaneous transmit and receive (STR) mode of operation using at least the first and second links; or
determining, based on consideration of power saving requirements of the non-AP MLD, to operate in a single link mode of operation using the second link; or
determining, based on the power savings requirements having a higher priority than the low latency or high throughput requirements, to operate either in an enhanced multi-link single radio (EMLSR) mode of operation using at least the first and second links or in the single link mode of operation using the first link; or
determining, based on the power savings requirements and the low latency or high throughput requirements being balanced, whether the non-AP MLD is in a high contention environment or a low contention environment, and:
determining, based on the non-AP MLD being in the high contention environment, to operate in the EMLSR mode of operation using at least the first and second links, or
determining, based on the non-AP MLD being in the low contention environment, to operate in the STR mode of operation using at least the first and second links; and
communicating with the AP MLD according to the determined mode of operation.

9. The method of claim 8, further comprising determining the low latency requirements of the traffic based on features of an application that generates the traffic.

10. The method of claim 8, further comprising:
determining, based on the low latency requirements or high throughput requirements of the traffic, to set up a stream classification service (SCS) with the AP MLD;
generating an SCS Request frame that includes a quality of service (QOS) Characteristics element that includes at least one parameter identifying the low latency requirements or high throughput requirements of the traffic; and
transmitting the SCS Request frame to the AP MLD.

11. The method of claim 8, further comprising:
determining, based on the low latency requirements or high throughput requirements of the traffic, to set up a mirrored stream classification service (MSCS) with the AP MLD;
generating an MSCS Request frame that includes a QoS Characteristics element that includes at least one parameter identifying the low latency requirements or high throughput requirements of the traffic; and
transmitting the MSCS Request frame to the AP MLD.

12. The method of claim 8, further comprising:
determining a number of overlapping basic service set (OBSS) APs in a neighborhood of the non-AP MLD; and
determining whether the non-AP MLD is in the high contention environment or the low contention environment based on the number of OBSS APS.

13. The method of claim 12, further comprising determining the number of OBSS APS based on:
identification of beacons received from APs other than the AP MLD, or
identification of APs other than the AP MLD from a list received from the AP MLD, the list including other APs that are in a neighborhood of the AP MLD.

14. The method of claim 8, further comprising determining the power savings requirements of the non-AP MLD based on:
applications that are running on the non-AP MLD, or
a power management status of the non-AP MLD.

15. A non-transitory computer-readable medium configured to store instructions that, when executed by a processor, cause a non-access point (AP) multi-link device (MLD) to:
determine, based on consideration of low latency requirements of traffic or high throughput requirements of the traffic, to operate in a simultaneous transmit and receive (STR) mode of operation using at least first and second links link formed between stations (STAs) of the non-AP MLD and corresponding APs of an AP MLD, wherein the first link operates in the 5 GHz frequency band and the second link operates in the 2.4 GHz frequency band; or
determine, based on consideration of power saving requirements of the non-AP MLD, to operate in a single link mode of operation using the second link; or
determine, based on the power savings requirements having a higher priority than the low latency or high throughput requirements, to operate either in an enhanced multi-link single radio (EMLSR) mode of operation using at least the first and second links or in the single link mode of operation using the first link; or
determine, based on the power savings requirements and the low latency or high throughput requirements being balanced, whether the non-AP MLD is in a high contention environment or a low contention environment, and:
determine, based on the non-AP MLD being in the high contention environment, to operate in the EMLSR mode of operation using at least the first and second links, or
determine, based on the non-AP MLD being in the low contention environment, to operate in the STR mode of operation using at least the first and second links; and
communicate with the AP MLD according to the determined mode of operation.

16. The non-transitory computer-readable medium of claim 15, wherein the instructions, when executed by the processor, further cause the non-AP MLD to determine the low latency requirements of the traffic based on features of an application that generates the traffic.

17. The non-transitory computer-readable medium of claim 15, wherein the instructions, when executed by the processor, further cause the non-AP MLD to:
determine, based on the low latency requirements or high throughput requirements of the traffic, to set up a stream classification service (SCS) with the AP MLD;
generate an SCS Request frame that includes a quality of service (QOS) Characteristics element that includes at least one parameter identifying the low latency requirements or high throughput requirements of the traffic; and
transmit the SCS Request frame to the AP MLD.

18. The non-transitory computer-readable medium of claim 15, wherein the instructions, when executed by the processor, further cause the non-AP MLD to:
determine, based on the low latency requirements or high throughput requirements of the traffic, to set up a mirrored stream classification service (MSCS) with the AP MLD;
generate an MSCS Request frame that includes a QoS Characteristics element that includes at least one parameter identifying the low latency requirements or high throughput requirements of the traffic; and
transmit the MSCS Request frame to the corresponding AP of the AP MLD.

19. The non-transitory computer-readable medium of claim 15, wherein the instructions, when executed by the processor, further cause the non-AP MLD to:
determine a number of overlapping basic service set (OBSS) APs in a neighborhood of the non-AP MLD; and
determine whether the non-AP MLD is in the high contention environment or the low contention environment based on the number of OBSS APS.

20. The non-transitory computer-readable medium of claim 15, wherein the instructions, when executed by the processor, further cause the non-AP MLD to determine the power savings requirements of the non-AP MLD based on:
applications that are running on the non-AP MLD, or
a power management status of the non-AP MLD.
